(19) United States
(12) Patent Application Publication
(10) Pub. No.: US 2018/0085674 A1
(43) Pub. Date: Mar. 29, 2018

(54) System and Method for Managing a Fantasy Football League

(71) Applicant: Peter Dustin, Camarillo, CA (US)

(72) Inventor: Peter Dustin, Camarillo, CA (US)

(21) Appl. No.: 15/277,635

(22) Filed: Sep. 27, 2016

(51) Int. Cl. A63F 13/828; A63F 13/73; A63F 13/35

(52) U.S. Cl. CPC A63F 13/828; A63F 13/35; A63F 13/73

(57) ABSTRACT

A system for playing fantasy football games over the Internet between first general manager and a second general manager of teams from a fantasy football league. The team for each general manager includes a roster of players selected from a real football league. The system includes a network center process controller, a client device associated with the first general manager and a second device associated with the second general manager. The network centric device is responsible for providing a standardized rating system and player statistics to the general manager client devices. After a game is completed, the network centric system determines a winner based on player statistics and the standardized rating system. The results are reported to the first and second client devices and the general manager client devices automatically audits the results to determine if the result is accurate.

### TECHNICAL FIELD

The present invention relates generally to a systems for managing and using on-line fantasy football leagues and, more particularly, to a data management system for managing, disseminating, and using fantasy football league data.

### BACKGROUND

Fantasy football leagues are competitive betting games that have become quite popular and are played by millions of people for the competition, fun, and the money. The leagues are generally played on-line by allowing participants to enter into a league, e.g. the National Football League (NFL), Canadian Football League (CFL), or a collegiate football league, as a general manager from one of the leagues mentioned. The general manager creates a team and stocks his or her team with players from the league entered making his or her choices based on real player statistics, e.g. from the NFL, made available by the league administrator. Each player available for selection is assigned by an administrator, often referred to as a commissioner, managing the league an asset value based on a predefined rating system. As such, each player has an asset value and the team as a whole has a value. These values are important to the general manager when considering a trade or adding assets. The values are also important when in actual competition. Actual competition occurs when a general managers pits his or her team against another team within the league for competition and betting purposes.

A serious issue for those participating in these fantasy football leagues is the potential for fraudulent or corrupt behavior. The participants in these leagues are dependent on the commissioner being fair and honest when administering player statistics and the statistics' rating system. If the commissioner is not honest and fair and injects bias into the game, the value of the assets are effected and the general managers competitiveness is effected. As an example, if general manager of team x and a general manager of team y engage in competition, how would either manager know the stats and/or rating system administered by the commissioner were not altered in a manner that would give an advantage to one or the other manager. To further explain, perhaps manager x has a Cam Newton as a quarterback on his or her roster and manager y has Tom Brady as a quarterback on his or her roster. Each quarterback has assigned statistics, such as total number of completions, number of attempts, total yards, etc. Each statistic is allocated a set number of points and the total points are allocated a value, which is the asset value. Based on these asset value's within competing teams, a winner can be determined. So, if manager -x pits his or her team against manager y and his or her team, depending on the results of each players performance and the totality of the performance of all players, an actual winner can be determined based on the point system and asset values. However, if the point system and/or statistics are manipulated in a way that makes the competition unfair, the integrity of the game is compromised. And typically, the root cause of this lies within the nature of administrator, i.e. the commissioner, of the system.

As such, there is a need for a fantasy football league system that, can function in a way to provide data integrity and security so that the commissioner can not interject biases that effect the outcome.

### SUMMARY

Techniques herein provide computer-implemented methods to manage and process fantasy football league data in a way that is transparent to the league players.

A system is provided for playing fantasy football between general managers of teams from a fantasy football league. The team for each general manager includes a roster of players selected by the general manager from a real football league. The system includes a network center process controller, a client device associated with a first general manager and a second device associated with a second general manager. The network centric device is responsible for providing a standardized rating system and player statistics to the general manager client devices. After a game is completed between the first and second general manager, the network centric system determines a winner based on player statistics and the standardized rating system. The results are reported to the first and second client devices and the general manager client devices automatically audits the results to determine if the result is accurate.

### BRIEF DESCRIPTION OF THE DRAWINGS

FIG. 1 is a system diagram depicting a system to manage, disseminate, and authenticate commissioner and general manager data, in accordance with certain example embodiments.

FIG. 2 A is a process flow diagram depicting a method used by a commissioner- server system to receive, process, disseminate, and store qualified commissioner and general manager data, in accordance with certain example embodiments.

FIG. 2B is a process flow diagram depicting a method used by a general manager client system to receive, process, disseminate, and store qualified commissioner and general manager data, in accordance with certain example embodiments.

FIG. 3A is a process flow diagram depicting a method used by the commissioner to initiate a game between two general managers and audit results.

FIG. 3B is a process flow diagram depicting a method used by the general manager to initiate a game between two general managers and audit results.

### DETAILED DESCRIPTION OF THE EXAMPLE EMBODIMENTS

The object of the described invention is to describe a client and server application system for managing and providing fantasy football league information in a secure and transparent manner in order to ensure information integrity.

The motivation for providing such a service is to provide team managers with a sense of security in knowing that competitions entered into are fair and not otherwise effected by league commissioner biases.

In an example embodiment, a network system service, typically administered by a league commissioner, processes and manages league data and information, such as player statistics, a standardized rating system, communication forums, game match making, betting, and funds distribution, and client devices operated by general managers make use of these services to manage a teams roster, place bets, and enter into competition. In order to satisfy the objective and motivation, the standardized rating system is distributed to all general managers within the league. Standardized in this sense is meant to convey that all general mangers have agreed upon the rules defining the rating system. In addition, the player statistics may also be distributed to all general managers within the league. Furthermore, the standardized rating system and, optionally, the player statistics may be digitally signed to ensure the integrity of the rating system and to prevent fraud on the part of the commissioner.

### Example System Architecture

Turning now to the drawings, in which like numerals represent like (but not necessarily identical) elements throughout the figures, example embodiments are described in detail.

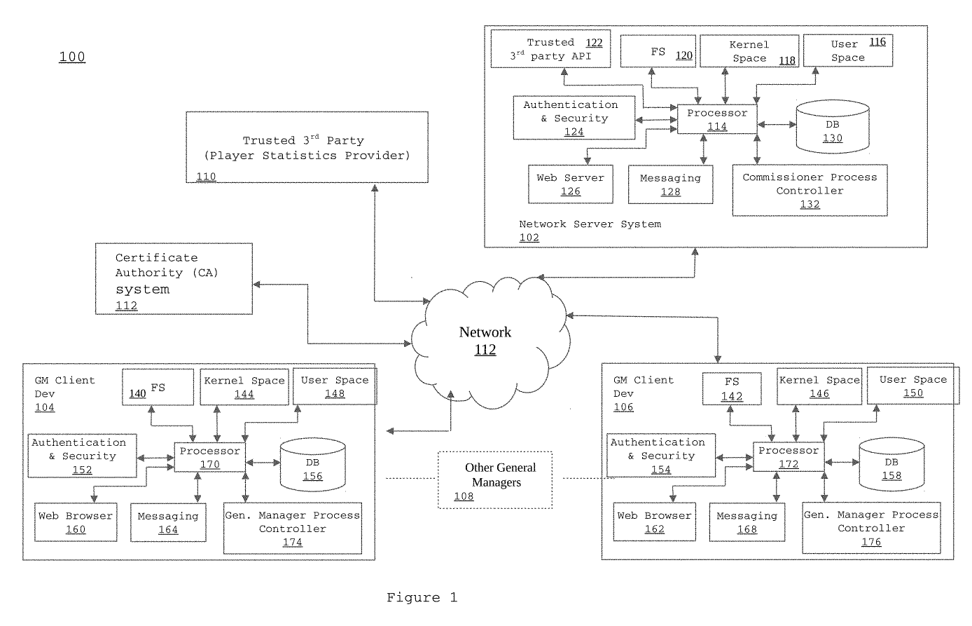

FIG. 1 is a block diagram depicting a system to manage and process fantasy football league data and information according to an embodiment of the invention and is denoted generally 100. The system 100 includes a network server system 102, a General Manager (GM) client device 104, a General Manager (GM) client device 106, other players 108, a trusted 3rd party statistics service provider 110, and a Certificate Authority (CA) system 112 and with all components coupled with a service provider network 112 or multiple service provider networks.

In the description that follows, the system 100 is described in reference to a situation where all general managers receive and manage a standardized rating system from network service system 102 and client device 104 and client device 106 enter into competition, i.e. a match pitting their teams against one another. In the discussion that follows, the particulars of the rating system is not particularly relevant. What is relevant is the rating system is previously agreed upon by all players and all players can verify authenticity and integrity of the rating system using the well known Public Key Infrastructure (PKI).

As depicted in FIG. 1, the network server system 102 includes a processor 114, user space applications 116, kernel space application 118, a File System (FS) 120, an optional trusted 3rd party API 122, an authentication and security application or applications 124, a web server 126, a messaging system 128, a database system 130, and a commissioner process controller 132. Also as depicted in FIG. 1, the GM client device 104 and GM Client device 106 each include, respectively, a FS 140, 142, kernel space applications 144, 146, user space applications 148,150, authentication and security application or applications 152, 154, a database system 156, 158, a web browser 160, 162, a messaging system 164, 168, a processor 170, 172, and a general manager process controller 174, 176. The trusted 3rd party API 122 has been described as optionally because the specifics of accessing a 3^{rd} party system to retrieve statistics may be specific requirements by the 3^{rd} party, e.g. registration information and specified user space applications needed for access, or alternatively the statistics could simply be -accessed using a web browser.

The description of system components provided for the network server system 102, the GM client device 104, and the GM client device 106 include many industry standard terms and applications. The system 102 and devices 104, 106, in this embodiment, use available open source operating systems and the applications made available within distribution systems that manage these operating systems. As such, it would be easily understood by one of ordinary skill in the art to understand the FS, kernel space applications, user space applications, authentication and security applications, web server, database system, and messaging server. As such, the focus forward will be on the novel and innovative features of the commissioner process controller 132, general manager process controller 174, 176, and the data and information managed. It should also be understood that the aforementioned controllers depend upon the open source tools previously mentioned in order to accomplish the goals of managing the data in a way that ensure information integrity and, therefore, fair match making.

As a practical example, the commissioner process controller 132 includes in its database 130 all registered general managers 104, 106, 108, and each GM client device registered has associated therewith at least the GM's roster, standardized rating system, and statistics for each player in the roster. The standardized rating system is predetermined in the sense that general managers within the league have agreed on the rating system used by the commissioner. In addition, GM client device 104 and GM client device 106, as well as all other general managers 108, have the same standardized rating system stored in their database, their own player statistics, and the calculated asset value for their player assets based on the standardized rating system. In this scenario, GM client device 104 and GM client device 106 can enter into competition through the intermediary, i.e. the commissioner process controller 132 provided by server system 102. At this point, the commissioner and general managers in competition have the same standardized rating system. So, as a league football game is actually played, statistics are changed and at the end of the game the statistics are provided to commissioner and general managers. From there, a value of the assets can be determined based on the standardized rating system and updated statistics and a winner of the competition can be determined.

In addition to the above, and with the motivation of providing fair competition, the standardized rating system, and optionally the player statistics provided from the trusted 3^{rd} party 110, may be digitally signed by the network server system 102 using the authentication and security application 124 and CA 112. The signed standardized rating system, and optionally the player statistics, can then be provided to the GM client devices and stored for use in calculating asset values and auditing actual selected winners in competition. Each GM client device can verify the authenticity of the agreed upon rating system, and optionally player statistics, with the CA 112. If there are any changes to the agreed upon standard, this can be easily determined.

### Example Processes

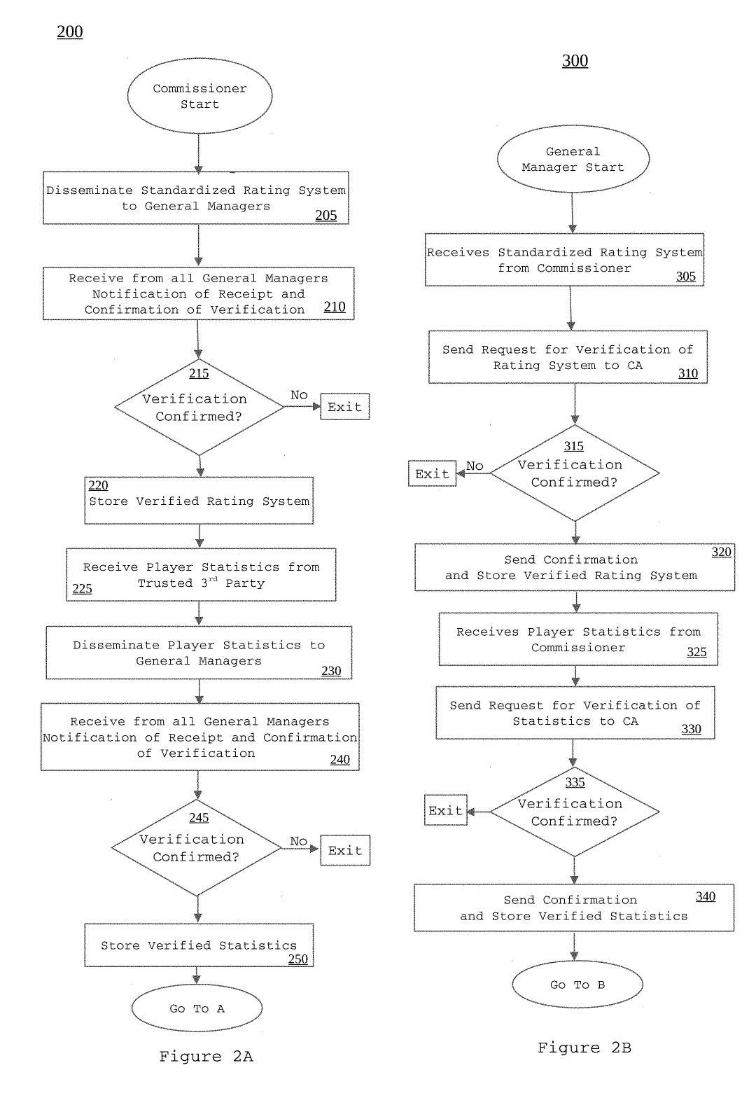

The example methods illustrated in FIG. 2A, 2B, 3A, and 3B are described hereinafter with respect to the components of the example operating environment 100. The example methods of FIG. 2A and 2B may also be performed with other systems and in other environments.

FIG. 2A and 2B are block flow diagrams depicting a first method 200 for process management of the commissioner process controller 132 of network service system 102 and a second method 300 for process management of the general manager processor controller 174, 176 of GM client device 104, 106. The process flow diagrams describes process methods that are used to manage and process .a standardized rating system and league player statistics so that the information is consistent between server and client processes.

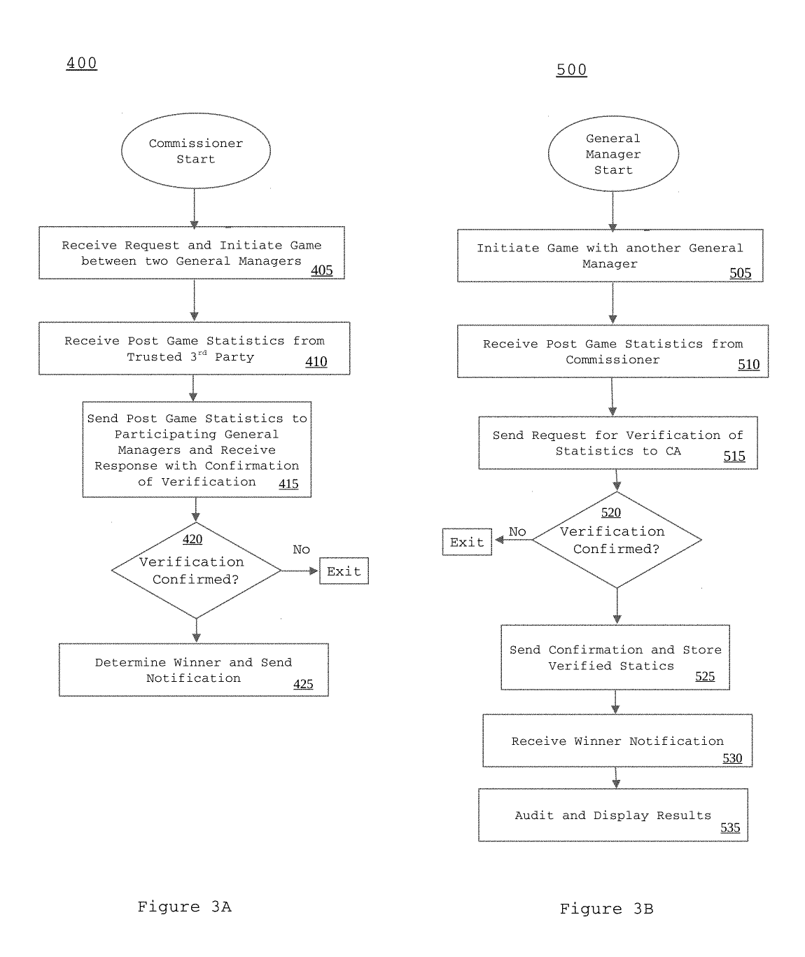

With respect to FIG. 2A, the commissioner process starts at step 205 wherein the commissioner process controller 132 disseminates a standardized rating system to GM client devices 104, 106, 108. It should also be understood that the standardized rating system may be digitally signed. At step 215, the process controller 132 determines which GM client devices 104, 106, 108, have verified receipt and confirmation of the received standardized rating system. With each device that does not confirm, the process is exited and no database updates for that device are made. If verification is received, the verified rating system is stored for that particular client device and is indicated as being accepted. At step 230, the process controller 132 receives from the trusted third party statistics for the league players. At step 230, the process controller 132 receives from all general managers notification of receipt of the player statics and, optionally, confirmation of verification. If verification is required and not received, the process controller 132 exits. If verification is required and received, the process controller 132 stores the verified statistics for each verification received from each manager and proceeds to process A, FIG. 3A.

With respect to FIG. 2B, the general manager process starts at step 305 where each GM client device 104, 106, 108 receives standardized rating system from commissioner 305. Next, at step 310, the GM client devices 104, 106, 108 send a request for verification of the rating system to the CA. If the verification is not confirmed, the process exits. If verification is confirmed the process continues to step 320 where the GM client devices 104, 106, 108 send confirmation back to the commissioner process controller 132 and store the verified rating system. Next, at step 325, the GM client devices receives the player statistics from the commissioner process controller 132. If verification of the statistics is required, at step 330, a verification request of the authenticity, of the statistics is sent to the CA 112. If verification is required and is not confirmed, at step 335, the process exits. If the verification is confirmed, at step 335, the process proceeds to step 340. If verification is not required, the statistics are stored at step 340. If verification is required and verified, the statistics are stored at 340. In either case, the process proceeds to process B, FIG. 3B.

FIG. 3A and 3B are block flow diagrams depicting a first method 400 and a second method 500 for using consistent information provided by the processes outlined in the block flow diagrams of FIG. 2A and 2B to play a fantasy league football game between GM client device 104 and GM client device 106. The processes are assumed to begin when the general managers enter into a match. The results are the match are determined upon an actual league game played and the player statistics captured from the results of that game. As such, this is where the process begins, upon completion of the game and provisioning of the player statistics as is supported in the process steps of FIGS. 2A and 2B.

With respect to FIG. 3A, the commissioner process starts at step 405 wherein the the commissioner process controller 132 receives a request to initiate a game or match between GM client device 104 and GM client device 106. Next, at step 410, the commissioner process controller 132 receives the post game statistics from the trusted 3^{rd} party. If the post game statistics are required by client devices, the post game statistics are sent to the GM client device 104 and GM client device 106 and in response a receipt of a confirmation of verification is received, at step 415. If confirmation is required and not received the process exits. If confirmation is required and received or if not required, the statistics are stored and a winner is determined, at step 425.

With respect to FIG. 3B, the general manager process starts at step 505 where GM client device 104 or GM client device 106 initiates a game with the other, step 505. At step 510, each GM client device 104, 106 receives post game statistics from commissioner process controller 132. Next at step 515, each GM client device 104, 106 has the option of verifying the authenticity of the statistics by sending the signed statistics to the CA 112. If the verification is required and is not confirmed, the process exits at step 520. If the verification is required and confirmed, the confirmation is sent to the process controller 132, at step 525. Next, at step 530, each GM client device 104, 106 receives the winner notification from the process controller 132. Next, at step 535, the results of the game are audited by each GM client device 104, 106 to verify the results. The verification is done by using the standardized rating system and player statistics to determine the outcome from the perspective of each client device.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. An system for managing dissemination of competitive fantasy football league information and managing the use of the information to determine a winner between league general managers, the system comprising;
a storage resource; and
a processor communicatively coupled to the storage resource, wherein the processor executes application code instruction that are stored in the storage resource to cause the system to:
receive a standardized rating system from a network centric commissioner;
send a request for verification of the standardized rating system to a certificate authority;
receive a response of verification from the certificate authority;
send a confirmation of a verification from the certificate authority to the network centric authority;
store the standardized rating system;
initiate a game with a league manager within the league;
receive player statistics from the network centric commissioner;
receive winner notification from network centric commissioner; and
compare standardized rating system with received player statistics to independently determine winner.

2. A computer program product, comprising:
a non-transitory computer-readable storage device having computer-executable program instructions embodied thereon that when executed by a computer cause the computer to process and disseminate standardized ratings data for use in determining an outcome between a competitive match between at least two participating player, the computer-executable program instructions comprising:
computer-executable program instruction to receive a standardized rating system from a network centric commissioner;
computer-executable program instructions to send a request for verification of the standardized rating system to a certificate authority;
computer-executable program instructions to receive a response of verification from the certificate authority;
computer-executable program instruction to send a confirmation of a verification from the certificate authority to the network centric authority;
computer-executable program instruction to store the standardized rating system;
computer-executable program instruction to initiate a game with a league manager within the league;
computer-executable program instruction to receive player statistics from the network centric commissioner;
computer-executable program instruction to receive winner notification from network centric commissioner; and
computer-executable program instruction compare standardized rating system with received player statistics to independently determine winner.
